(19) United States
(12) Patent Application Publication
(10) Pub. No.: US 2003/0223922 A1
(43) Pub. Date: Dec. 4, 2003

(54) Structure and method for improving metal honeycomb core body of catalyst converters

(75) Inventor: Charles Hsu, Taoyuan (TW)

Correspondence Address: BACON & THOMAS, PLLC, 625 SLATERS LANE, FOURTH FLOOR, ALEXANDRIA, VA, 22314

(73) Assignee: CHARLES HSU, Taoyuan (TW)

(21) Appl. No.: 10/159,258

(22) Filed: Jun. 3, 2002

(51) Int. Cl. B01D 53/34

(52) U.S. Cl. 422/180; 422/177; 29/890

(57) ABSTRACT

The present invention provides a structure and a method for improving metal honeycomb core body of catalyst converters, which is composed of an elongate matrix having a flat sheet and a corrugated sheet. Said flat sheet and said corrugated sheet are superimposed and rolled up to form a central heat-resistant structure and a honeycomb structure for improving metal honeycomb core body of catalyst converters. Wherein said central heat-resistant structure having a specific diameter substantially larger than 10 mm for forming at least a diffusion channel to increase the exhausting gas flowing through and decrease the temperature therein; and said honeycomb structure surrounding said central heat-resistant structure for catalytic reaction. Due to the catalytic reaction area of said diffusion channel is very small, it reduces the efficiency of reaction in the center portion of the metal honeycomb core body of catalyst converter, and it further reduces temperature increasing by its exothermic reaction.

### FIELD OF THE INVENTION

The present invention is related to metal honeycomb core body of catalyst converters, more particularly, related to improving the center portion of honeycomb core body of catalyst converters with an easier fabricating method.

### BACKGROUND OF THE INVENTION

In general, catalyst converters are adapted to use under high temperature environment by a heat-resistant honeycomb structure for purifying exhausting toxic gas. An elongate matrix having a flat sheet and a corrugated sheet are superimposed and rolled up for forming the aforementioned heat-resistant honeycomb structure.

Please referring to FIG. 1A˜1D, the prior art of catalyst converters for purifying the exhausting gas from an engine (such as the general gas engine), which are formed by an elongate matrix 1 having a flat sheet 12 and a corrugated sheet 11, wherein said elongate matrix 1 is applied with soldering material thereon. A predetermined line A-A is set at the adjacence of said flat sheet 12 and said corrugated sheet 11 for being superimposed and rolled up to form a honeycomb structure 10. Then, inserting said honeycomb structure 10 into a hollow cylindrical shell 3 to form a catalyst converter (as shown in the FIG. 1D) by heating process, wherein said hollow cylindrical shell 3 is applied with soldering material on the inner wall thereof for fixing said honeycomb structure 10 into said hollow cylindrical shell 3 after heating process. Said honeycomb structure 10 further comprises a plurality of channel 100 for the exhausting gas flowing through. The surface of the honeycomb structure 10 is covered with catalyst, such as the noble metal catalyst: platinum Pt, palladium Pd, and rhodium Rh, to change the noxious emissions, such as carbon monoxide (CO), hydrocarbons (HC), and nitrogen oxides (NOX), into non-toxic gas, such as carbon dioxide (CO₂), water (H₂O), and nitrogen (N₂) by the catalytic action for purifying the exhausting toxic gas from an engine. In addition, the catalytic action is an exothermic reaction, so the higher performance of the catalyst converter reacts, the higher thermal will be generated. However, when gas flows through the honeycomb structure 10, the speed of the gas flowing through the center of the honeycomb structure 10 is the fastest, by contrast, the farther the gas flows through away from the center of the honeycomb structure 10, the lower the speed of gas flows through therein. Thus, according to the fastest speed of the gas flowing through the center portion, it generates the highest temperature therein, and the temperature in the center portion of the honeycomb structure 10 is the highest. When the gas engine is under high-loaded or unfired status, the incompletely reacted gas flows through the honeycomb structure 10 causes temperature increasing dramatically in its center portion, even over 1,200° C., and furthermore, causes the center portion of the honeycomb structure melted and destroys the whole catalyst converter. In the U.S. Pat. No. 5,302,355, Exhaust Purifying Device and Method of Producing the same, which discloses an exhaust purifying device for an internal combustion engine. Its honeycomb core is constituted by a single webbing that is implemented as foil of stainless steel. The webbing is made up of a flat portion and a corrugated portion adjoining each other in the longitudinal direction of the webbing. The flat portion is held by a core metal forming part of a jig at a particular position that is a predetermined distance remote from a position where the corrugated portion begins. The core metal is rotated about its own axis in such a direction that the flat portion underlies the corrugated portion and forms a small hole therein. However, the diameter of that small hole is usually smaller than 10 mm, therefore, the center portion of the core metal is easy to be melted.

In order to solve the problem of center portion of the honeycomb structure melted by high thermal exothermic reaction, it is important to provide a structure and a method for improving metal honeycomb core body of catalyst converters. Therefore, the present invention is provided to reduce the high temperature in the center of the metal honeycomb core body of catalyst converters, and further to avoid the structure to be destroyed by high thermal reaction. In addition, another object of the present invention is to reduce consumption of an engine horsepower by decreasing the back pressure caused by the exhausted gas resistance.

### SUMMARY

The present invention provides a structure and a method for improving metal honeycomb core body of catalyst converters, which is composed of an elongate matrix having a flat sheet and a corrugated sheet. Said flat sheet and said corrugated sheet are superimposed and rolled up to form a central heat-resistant structure and a honeycomb structure for improving metal honeycomb core body of catalyst converters; wherein said central heat-resistant structure having a specific diameter substantially larger than 10 mm for forming at least a diffusion channel to increase the exhausting gas flowing through and decrease the temperature therein; and said honeycomb structure surrounding said central heat-resistant structure for catalytic reaction. Due to the catalytic reaction area of said diffusion channel is very small, it reduces the efficiency of reaction in the center portion of the metal honeycomb core body of catalyst converter, and it further reduces temperature increasing by its exothermic reaction.

### BRIEF DESCRIPTION OF THE DRAWINGS

The present invention will be better understood from the following detailed description of preferred embodiments of the invention, taken in conjunction with the accompanying drawings, in which

FIG. 1A is a perspective view of a single matrix of a traditional honeycomb core;

FIG. 1B is a side elevation of FIG. 1A;

FIG. 1C is a section showing the traditional honeycomb core formed by the procedure of FIG. 1B;

FIG. 1D is an exploded perspective view of a traditional catalyst converter;

FIG. 2 is a side elevation of a single matrix for constituting a honeycomb core embodying the present invention;

FIG. 3A is an exploded perspective view of a catalyst converter;

FIG. 3B is an exploded perspective view of a central heat-resistant structure of the honeycomb core in accordance with the present invention; and

FIG. 4 is an exploded perspective view of a catalyst converter embodying the present invention formed by the procedure of FIG. 3A.

### DESCRIPTION OF THE PREFERRED EMBODIMENTS

The following descriptions of the preferred embodiments are provided to understand the features of the present invention.

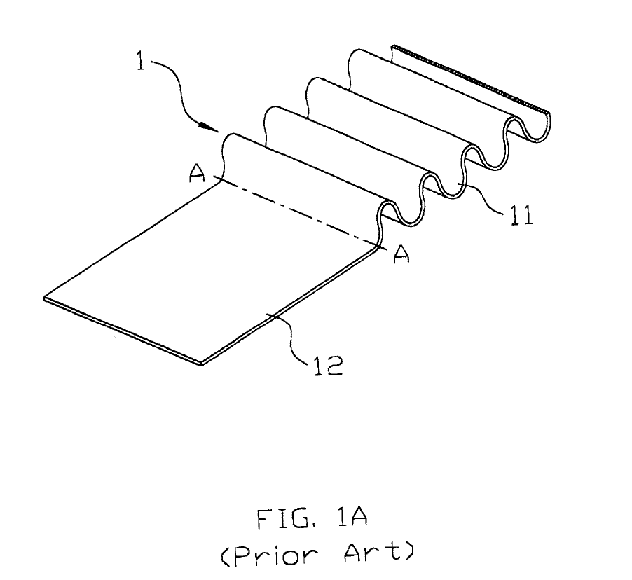

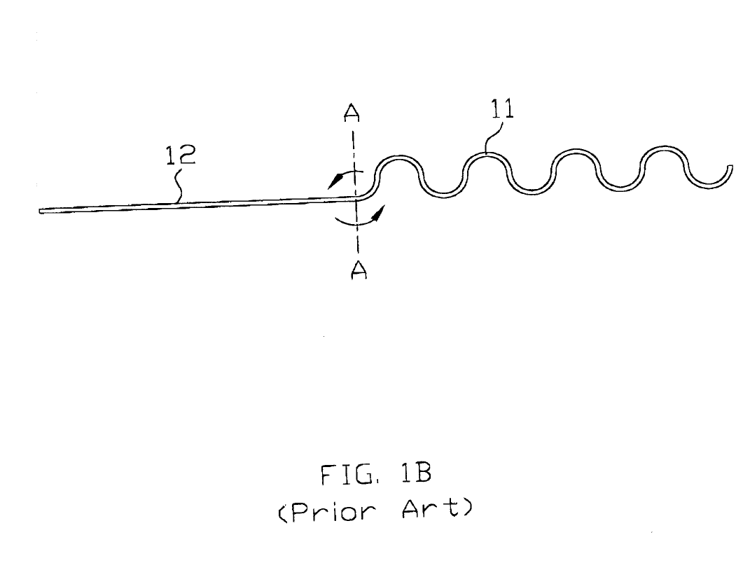

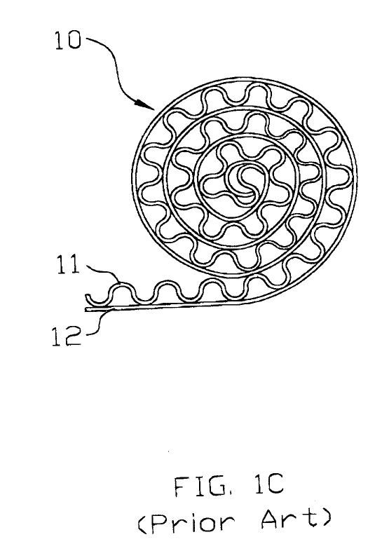

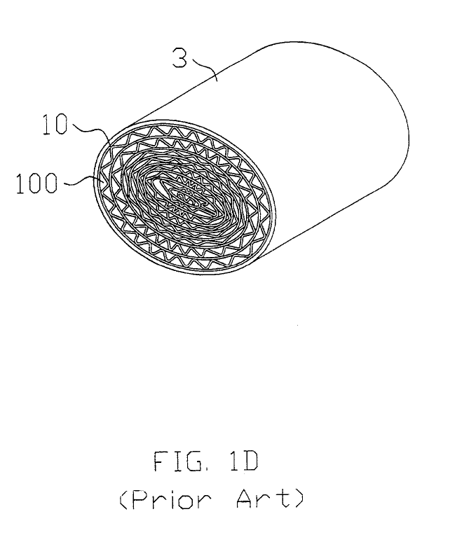

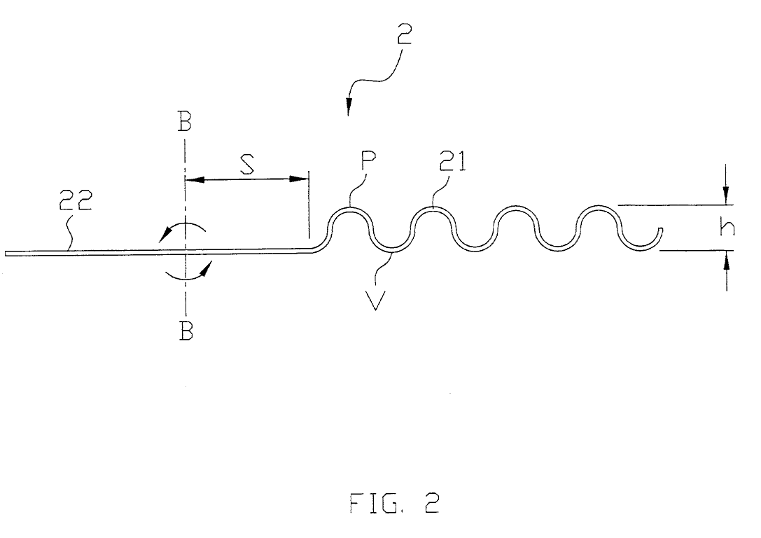

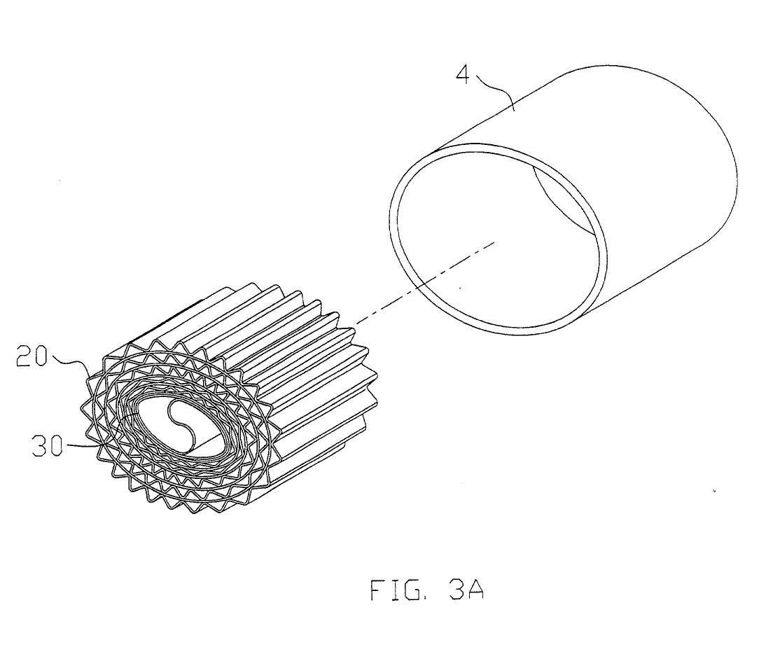

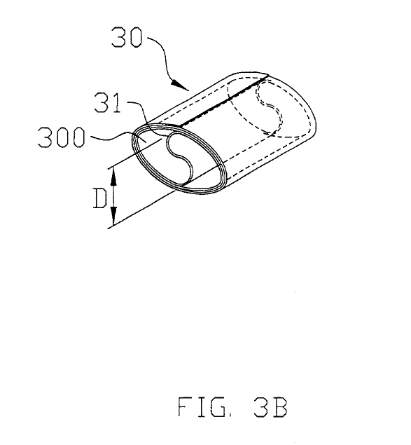

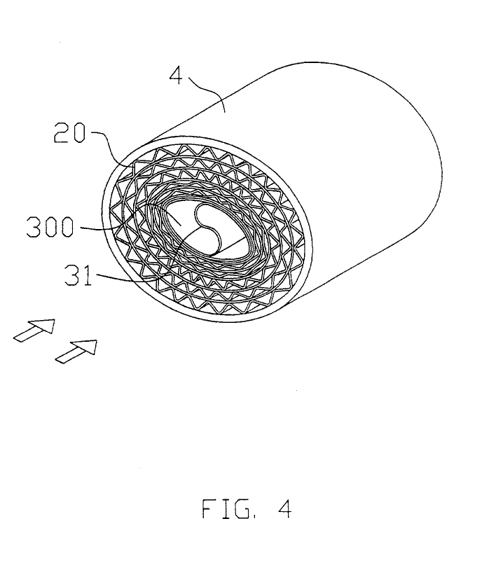

The present invention provides a structure for improving metal honeycomb core body of catalyst converters, please referring to the FIG. 2, which is composed of an elongate matrix 2 having a flat sheet 22 and a corrugated sheet 21, in a preferred embodiment, said matrix 2 is applied with soldering material. After setting a predetermined line B-B, the flat sheet 22 and corrugated sheet 21 are superimposed and rolled up from the line B-B. In the preferred embodiment, said elongate matrix 2 is composed of a alloy foil having soldering material applied thereon; wherein said alloy foil is selected from the group consisting of iron, chromium, and aluminum. Furthermore, the predetermined line B-B is located on said flat sheet 22 and remote from the adjacence of said flat sheet 22 and said corrugated sheet 21 (as the A-A line, shown in FIG. 1A), which demonstrates a specific distance S between the adjacency and line B-B. Next, referring to the FIG. 3A, after superimposing and rolling up said flat sheet 22 and said corrugated sheet 21, a central heat-resistant structure 30 and a honeycomb structure 20 are formed through appropriate heating process; wherein the honeycomb structure 20 is located around the central heat-resistant structure 30. A hollow cylindrical shell 4 is provided for inserting the honeycomb structure 20 and the central heat-resistant structure 30 into therein, in the preferred embodiment, said hollow cylindrical shell 4 is composed of heat-resistant stainless steel and applied with soldering material on its inner wall for fixing the honeycomb structure 20 and the central heat-resistant structure 30 after the heating process, as shown in the FIG. 4, which is employed for purifying the exhausting gas, for example for the catalyst converter of a gas engine. Particularly, the distance S is based on the specific diameter D of said central heat-resistant structure 30, and moreover, said diameter D is much longer than the height h (between the peaks of p and v), as shown in the FIG. 2. In the preferred embodiment, said diameter D is substantially larger than 10 mm for forming said diffusion channel 300 to increase the exhausting gas flowing through and decrease the temperature therein.

Please referring to the FIG. 3B, due to the diameter D of the central heat-resistant structure 30 is substantially larger than 10 mm, the diffusion channel 300 has a greater diffusion space for decreasing the back pressure caused by the exhausting gas resistance; and furthermore, due to the area of catalytic action is comparatively small, the thermal increased by the exothermic catalytic reactions is decreasing, and it may avoid the structure of the central portion to be melted and destroyed. Therefore, the consumption of horsepower of the engine (such as the gas engine) may be reduced. The central heat-resistant structure 30 further comprises a supporting portion 31 for supporting said honeycomb structure 20, and furthermore, for avoiding its structure deformed.

The present invention provides a method for improving metal honeycomb core body of catalyst converters, referring to the FIG. 2˜FIG. 4, first, providing an elongate matrix 2, wherein said elongate matrix 2 having a flat sheet 22 and a corrugated sheet 21, and furthermore, a predetermined line B-B being set on said flat sheet 22. In the preferred embodiment, said elongate matrix 2 is composed of a alloy foil having soldering material applied thereon and selected from the group consisting of iron, chromium, and aluminum. And second, superimposing and rolling up said flat sheet 22 and said corrugated sheet 21 from said determined line B-B. Then, it forms a central heat-resistant structure 30 and a honeycomb structure 20 after heating process, wherein said central heat-resistant structure 30 has a specific diameter D larger than 10 mm, and said honeycomb structure 20 is surrounding said central heat-resistant structure 30. Next, inserting said central heat-resistant structure 30 and said honeycomb structure 20 into a hollow cylindrical shell 4, in the preferred embodiment, said hollow cylindrical shell 4 is composed of stainless steel and applied with soldering material on its inner wall. Said central heat-resistant structure 30 and said honeycomb structure 20 will be fixing into said hollow cylindrical shell 4 by vacuum soldering process, as shown in FIG. 4 for the exploded perspective view. A diffusion channel is formed for increasing the exhausting gas flowing through and decreasing the temperature of said metal honeycomb core body of catalyst converters. Furthermore, the predetermined line B-B is located on said flat sheet 22 and remote from the adjacence of said flat sheet 22 and said corrugated sheet 21 (as the A-A line, shown in FIG. 1A), which demonstrates a specific distance S between the adjacency and line B-B. Particularly, the distance S is based on the specific diameter D of said central heat-resistant structure 30, and moreover, said diameter D is much longer than the height h (between the peaks of p and v), as shown in the FIG. 2. In the preferred embodiment, said diameter D is substantially larger than 10 mm for forming said diffusion channel 300 to increase the exhausting gas flowing through and decrease the temperature therein. Due to the diameter D of the central heat-resistant structure 30 is substantially larger than 10 mm, referring to the FIG. 3B, the diffusion channel 300 has a greater diffusion space for decreasing the back pressure caused by the exhausting gas resistance; and furthermore, due to the area of catalytic action is comparatively small, the thermal increased by the exothermic catalytic reactions is decreasing, and it may avoid the structure of the central portion to be melted and destroyed. Therefore, the consumption of horsepower of the engine (such as the gas engine) may be reduced. The central heat-resistant structure 30 further comprises a supporting portion 31 for supporting said honeycomb structure 20, and furthermore, for avoiding its structure deformed.

The present invention may be embodied in other specific forms without departing from the spirit of the essential attributes thereof; therefore, the illustrated embodiment should be considered in all respects as illustrative and not restrictive, reference being made to the appended claims rather than to the foregoing description to indicate the scope of the invention.

In summation of the foregoing section, the improved structure for improving metal honeycomb core body of catalyst converters of the invention herein is an invention of reasonable perfection that not only possesses outstanding practicality, but has an unprecedented structural spatial design that is original and innovative and, furthermore, adapting a diffusion channel have a larger space for exhausting gas flowing through and a greater rate of decreasing horsepower of the engine that is manifestly capable of increased catalyst converters performance, is a solution to the height characteristics of inventions based on the conventional technology and, furthermore, is progressive and not a conception based merely on familiarity of utilization; therefore, the invention herein fully complies will all new patent application requirements and is hereby submitted to the patent bureau for review and the granting of the commensurate patent rights.

What is claimed is:

1. A structure for improving metal honeycomb core body of catalyst converters being composed of an elongate matrix having a flat sheet and a corrugated sheet, the improvement comprises:
a central heat-resistant structure having a specific diameter substantially larger than 10 mm for forming at least a diffusion channel to increase the exhausting gas flowing through and decrease the temperature therein; and a honeycomb structure surrounding said central heat-resistant structure;
wherein said central heat-resistant structure and said honeycomb structure are formed by said flat sheet and said corrugated sheet superimposed and rolled up for improving metal honeycomb core body of catalyst converters.

2. The structure according to claim 1, wherein said central heat-resistant structure further comprises a supporting portion for supporting said honeycomb structure.

3. The structure according to claim 1, said elongate matrix is composed of a alloy foil having soldering material applied thereon so as to form said central heat-resistant structure and said honeycomb structure after heating process; wherein said alloy foil is selected from the group consisting of iron, chromium, and aluminum.

4. The structure according to claim 1, said metal honeycomb core body further comprises a hollow cylindrical shell composed of heat-resistant stainless steel for inserting said central heat-resistant structure and said honeycomb structure into therein; wherein said hollow cylindrical shell has soldering material applied on the inner wall thereof for fixing said central heat-resistant structure and said honeycomb structure into therein after heating process.

5. A method for improving metal honeycomb core body of catalyst converters comprising the steps of:
a.) providing an elongate matrix, wherein said elongate matrix having a flat sheet and a corrugated sheet;
b.) superimposing and rolling up said flat sheet and said corrugated sheet from a determined line on said flat sheet;
c.) forming a central heat-resistant structure and a honeycomb structure, wherein said central heat-resistant structure has a specific diameter larger than 10 mm, and said honeycomb structure is surrounding said central heat-resistant structure;
d.) inserting said central heat-resistant structure and said honeycomb structure into a hollow cylindrical shell;
e.) fixing said central heat-resistant structure and said honeycomb structure into said hollow cylindrical shell by vacuum soldering process; and
f.) forming a diffusion channel for said metal honeycomb core body of catalyst converters to increase the exhausting gas flowing through and decrease the temperature therein.

6. The method according to claim 5, wherein said central heat-resistant structure further comprises a supporting portion for supporting said honeycomb structure.

7. The method according to claim 5, the step of providing said elongate matrix further comprising the step of: applying soldering material on said matrix, after the step of superimposing and rolling up said flat sheet and said corrugated sheet to form said central heat-resistant structure and said honeycomb structure by heating process;
wherein said elongate matrix is composed of a alloy foil selected from the group consisting of iron, chromium, and aluminum.

8. The method according to claim 5, before the step of inserting into said hollow cylindrical shell further comprises the step of applying soldering material on a inner wall of said hollow cylindrical shell and fixing said central heat-resistant structure and said honeycomb structure into said hollow cylindrical shell by heating process.
